(19) United States
(12) Patent Application Publication
(10) Pub. No.: US 2011/0167312 A1
(43) Pub. Date: Jul. 7, 2011

(54) RADIO TRANSMISSION DEVICE AND RADIO TRANSMISSION METHOD

(75) Inventors: Yoshihiko Ogawa, Kanagawa (JP); Seigo Nakao, Kanagawa (JP); Katsuhiko Hiramatsu, Kanagawa (JP); Daichi Imamura, Kanagawa (JP); Masayuki Hoshino, Kanagawa (JP); Atsushi Sumasu, Kanagawa (JP); Ayako Horiuchi, Kanagawa (JP); Sadaki Futagi, Ishikawa (JP); Masaru Fukuoka, Ishikawa (JP); Takashi Iwai, Ishikawa (JP)

(73) Assignee: PANASONIC CORPORATION, Osaka (JP)

(21) Appl. No.: 13/063,163

(22) PCT Filed: Sep. 28, 2009
(86) PCT No.: PCT/JP2009/004927

§ 371 Date: Mar. 9, 2011

(30) Foreign Application Priority Data
Sep. 29, 2008 (JP) 2008-250617

(51) Int. Cl. G06F 11/14

(52) U.S. Cl. 714/749; 714/E11.141

(57) ABSTRACT

Provided are a radio transmission device and a radio transmission method which can reduce the transmission packet collision generation ratio even when no resource allocation signal is detected in retransmission. When control information outputted from a decoding unit (204) contains NACK and retransmission Grant, a retransmission resource check unit (205) determines that the resource indicated by the retransmission Grant is the retransmission resource. Moreover, when no retransmission Grant is detected and the initial transmission is a wideband transmission, the retransmission resource check unit (205) determines that no retransmission resource exists and instructs an RB allocation unit (209) to stop retransmission. Moreover, when no retransmission Grant is detected and the initial transmission is a narrow band transmission, a predetermined resource is determined to be the retransmission resource.

### TECHNICAL FIELD

The present invention relates to a radio transmitting apparatus and a radio transmitting method for performing retransmission.

### BACKGROUND ART

HARQ (Hybrid Auto Repeat reQuest) is one error control technique. HARQ is a technique whereby the transmitting side retransmits a packet that has resulted in a failure and the receiving side combines the received packet and the retransmitted packet to improve error correction performance and realize high quality transmission. This HARQ technique is adopted in HSDPA (High Speed Downlink Packet Access) and LTE (Long Term Evolution).

As a HARQ method, adaptive HARQ and non-adaptive HARQ are under study. Adaptive HARQ is a method for allocating retransmitted packets to arbitrary resources. On the other hand, non-adaptive HARQ is a method for allocating retransmitted packets to predetermined resources.

Adaptive HARQ allocates packets to resources having high propagation path quality during transmission, and can thereby improve the error rate of packets and reduce the number of retransmissions. On the contrary, since adaptive HARQ allocates packets to arbitrary resources, adaptive HARQ requires signaling for reporting the positions where packets are allocated to resources, for each packet transmission, resulting in a problem that signaling overhead increases.

On the other hand, non-adaptive HARQ allocates packets to predetermined resources, and therefore the propagation path quality during transmission cannot always be said to be good and its packet error rate is an average rate, and thus the number of retransmissions tends to increase. On the other hand, since packets are allocated to predetermined resources, there is no need to report the position of a resource to which a packet is allocated for each packet transmission, providing an advantage that signaling overhead is small.

Thus, there is a trade-off relationship between adaptive HARQ and non-adaptive HARQ regarding the number of retransmissions and signaling overhead. Therefore, semi-adaptive HARQ which combines adaptive HARQ and non-adaptive HARQ is proposed as a method for solving the trade-off relationship.

Here, semi-adaptive HARQ will be described assuming uplink packet transmission. According to semi-adaptive HARQ, a base station performs signaling for reporting resource positions (that is, scheduling information) only when wishing to change resource allocation. When a radio communication terminal apparatus (hereinafter simply referred to as “terminal”) cannot receive signaling from the base station, the terminal judges that scheduling information directed to that terminal has not been transmitted from the base station, and transmits packets using a predetermined resource. On the other hand, when the terminal has successfully received signaling from the base station, the terminal transmits packets at resource positions reported through signaling. That is, the terminal switches between adaptive HARQ and non-adaptive HARQ according to the presence/absence of signaling from the base station.

Thus, according to semi-adaptive HARQ, the base station needs only to transmit signaling as required and change positions of resources to which packets are allocated, and can thereby reduce the number of retransmissions with less signaling overhead.

### CITATION LIST

### Non-Patent Literature

### NPL 1

3GPP TS 36.300 V8.3.0 Technical Specification Group Radio Access Network; E-UTRA and E-UTRAN; Overall description; Stage 2 (Release 8), “11 Scheduling and Rate Control”

### SUMMARY OF INVENTION

### Technical Problem

However, according to the above described technique, when a terminal cannot detect any resource allocation signal, packets are transmitted using a predetermined resource, and therefore when another terminal transmits packets using the same resources, there is a problem that packet collision occurs.

It is therefore an object of the present invention to provide a radio transmitting apparatus and a radio transmitting method for reducing the rate of occurrence of collision between transmission packets even when a resource allocation signal cannot be detected in retransmission.

### Solution to Problem

The radio transmitting apparatus according to the present invention adopts a configuration including a resource allocation section that allocates resources to transmission data, a transmitting section that transmits the transmission data to which resources are allocated and a retransmission resource determining section that commands the resource allocation section to stop retransmission when an initial transmission uses a transmission bandwidth equal to or more than a predetermined value and no retransmission resource allocation signal has been detected.

The radio transmitting method of the present invention includes a resource allocating step of allocating resources to transmission data, a transmitting step of transmitting the transmission data to which resources are allocated and a retransmission resource determining step of stopping retransmission when an initial transmission uses a transmission bandwidth equal to or more than a predetermined value and no retransmission resource allocation signal has been detected.

### Advantageous Effects of Invention

According to the present invention, it is possible to reduce the rate of occurrence of collision between transmission packets even when no resource allocation signal can be detected in retransmission.

### BRIEF DESCRIPTION OF DRAWINGS

FIG. 1 is a block diagram illustrating a configuration of a base station according to Embodiment 1 of the present invention;

FIG. 2 is a block diagram illustrating a configuration of a terminal according to Embodiment 1 of the present invention;

FIG. 3 illustrates how resources collide with each other in retransmission of wideband transmission and retransmission of narrow band transmission;

FIG. 4 is a diagram illustrating how processing is repeated every N times; and

FIG. 5 is a diagram illustrating how processing is repeated every N times.

### DESCRIPTION OF EMBODIMENTS

Hereinafter, embodiments of the present invention will be described in detail with reference to the accompanying drawings.

However, components having the same function will be assigned the same reference numerals in the embodiments and overlapping descriptions thereof will be omitted.

### Embodiment 1

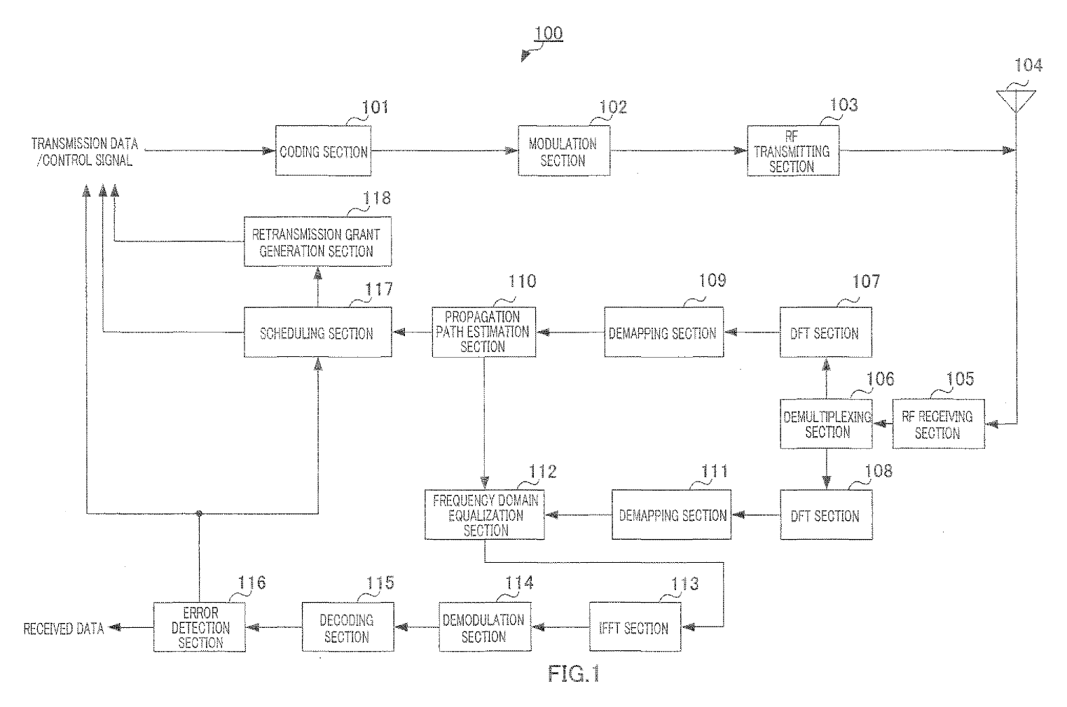

FIG. 1 is a block diagram illustrating a configuration of base station 100 according to Embodiment 1 of the present invention. In FIG. 1, coding section 101 applies coding processing to inputted transmission data and control information, generates codeword data and outputs the codeword data to modulation section 102. Modulation section 102 applies modulation processing to the codeword data outputted from coding section 101, generates a data symbol and outputs the data symbol to RF transmitting section 103. RF transmitting section 103 applies transmission processing such as D/A conversion, amplification and up-conversion to the data symbol outputted from modulation section 102 and transmits the data symbol from antenna 104 to each terminal.

RF receiving section 105 applies reception processing such as down-conversion, A/D conversion to a signal from each terminal received via antenna 104 and outputs the signal to demultiplexing section 106.

Demultiplexing section 106 demultiplexes the signal outputted from RF receiving section 105 into a pilot signal and other data signal and control signal, outputs the pilot signal to DFT (Discrete Fourier Transform) section 107 and outputs the data signal and control signal to DFT section 108.

DFT section 107 applies DFT processing to the pilot signal outputted from demultiplexing section 106, outputs the pilot signal to demapping section 109 and DFT section 108 applies DFT processing to the data signal and control signal outputted from demultiplexing section 106 and outputs the data signal and control signal to demapping section 111.

Demapping section 109 extracts a portion of the pilot signal outputted from DFT section 107 corresponding to a transmission band of each terminal and outputs the portion to propagation path estimation section 110.

Propagation path estimation section 110 estimates a frequency fluctuation in a propagation path and receiving quality using a signal outputted from demapping section 109, outputs an estimate value of the frequency fluctuation to frequency domain equalization section 112 and outputs the estimate value of receiving quality to scheduling section 117.

On the other hand, demapping section 111 extracts a portion of the data signal and control signal outputted from DFT section 108 corresponding to a transmission band of each terminal and outputs the portion to frequency domain equalization section 112.

Frequency domain equalization section 112 performs equalization processing in a frequency domain on the data signal and control information outputted from demapping section 111 using the estimate value of the frequency fluctuation in the propagation path outputted from propagation path measuring section 110 and outputs the signal subjected to the equalization processing to IFFT (Inverse Fast Fourier Transform) section 113.

IFFT section 113 applies IFFT processing to the signal outputted from frequency domain equalization section 112 and outputs the signal to demodulation section 114. Demodulation section 114 applies demodulation processing to the data signal and control signal outputted from IFFT section 113 and outputs the data signal and control signal to decoding section 115. Decoding section 115 performs decoding processing on the signal outputted from demodulation section 114 and outputs the signal to error detection section 116.

Error detection section 116 performs error detection on a decoded bit sequence outputted from decoding section 115. For example, error detection section 116 performs error detection using CRC (Cyclic Redundancy Check). When the error detection result shows an error in the decoded bit sequence, a NACK signal (control information) is generated as a response signal, and, on the other hand, when there is no error in decoding, an ACK signal (control information) is generated as a response signal. An ACK/NACK signal is outputted to coding section 101 and scheduling section 117 as control information. Furthermore, when there is no error in the decoded bit sequence, the decoded bit sequence is outputted as a received bit sequence (received data).

Scheduling section 117 allocates a frequency to each terminal (scheduling) using the estimate value of the receiving quality outputted from propagation path estimation section 110 and outputs scheduling information to coding section 101 and retransmission grant generation section 118 as control information.

Retransmission grant generation section 118 generates retransmission grant (resource allocation information or scheduling information) for a terminal using a bandwidth (wideband transmission) equal to or more than a predetermined threshold in initial transmission and outputs the retransmission grant to coding section 101 as control information. Furthermore, retransmission grant generation section 118 selects the presence/absence of retransmission grant for a terminal using a bandwidth (narrow band transmission) less than the predetermined threshold in initial transmission, generates retransmission grant if the retransmission grant is necessary and outputs the retransmission grant to coding section 101 as control information.

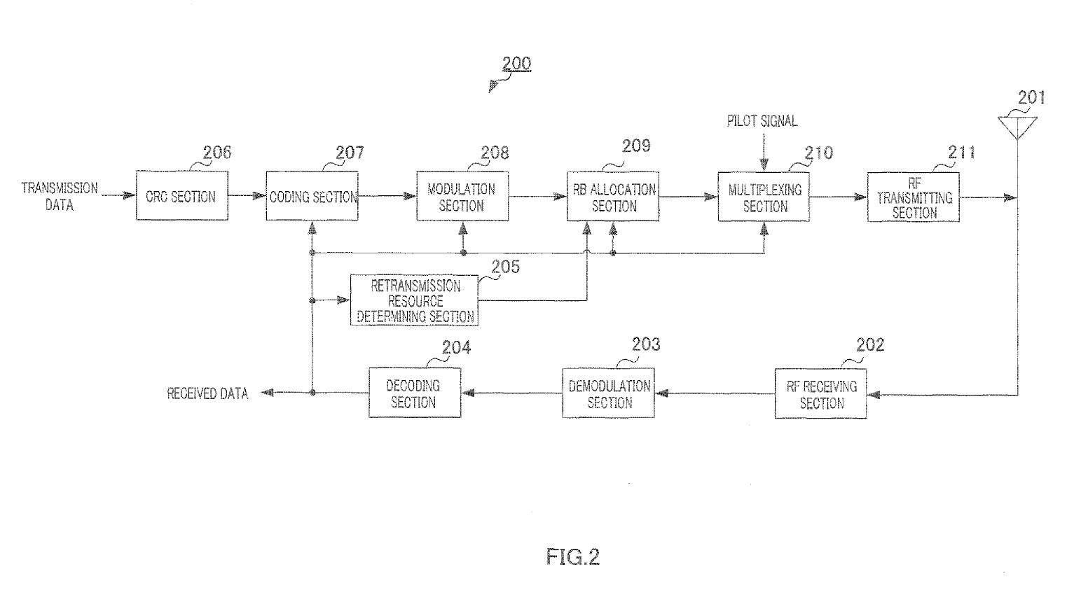

FIG. 2 is a block diagram illustrating a configuration of terminal 200 according to Embodiment 1 of the present invention. In FIG. 2, RF receiving section 202 receives a signal transmitted from base station 100 via antenna 201, applies reception processing such as down-conversion and A/D conversion to the received signal and outputs the received signal to demodulation section 203. Demodulation section 203 performs equalization processing and demodulation processing on the signal outputted from RF receiving section 202 and outputs the signal to decoding section 204. Decoding section 204 applies decoding processing to the signal outputted from demodulation section 203 and extracts a data signal and control information. Here, the control information is outputted to retransmission resource determining section 205, coding section 207, modulation section 208, RB (Resource Block) allocation section 209 and multiplexing section 210. The control information includes in formation such as retransmission grant, ACK/NACK information and bandwidth of initial transmission.

When the control information outputted from decoding section 204 includes a NACK and retransmission grant, retransmission resource determining section 205 judges that the resource indicated by the retransmission grant is a retransmission resource and outputs the retransmission resource to RB allocation section 209. However, when no retransmission grant can be detected and the initial transmission is wideband transmission, retransmission resource determining section 205 judges that there is no retransmission resource and commands RB allocation section 209 to stop retransmission. Furthermore, when no retransmission grant can be detected and the initial transmission is narrow band transmission, retransmission resource determining section 205 judges that the predetermined resource is a retransmission resource and outputs the retransmission resource to RB allocation section 209.

CRC section 206 applies error detection coding to a transmission data string inputted and outputs the transmission data string to coding section 207. Coding section 207 applies coding processing to the signal outputted from CRC section 206 based on the control information outputted from decoding section 204, generates codeword data and outputs the codeword data to modulation section 208. Modulation section 208 applies modulation processing to the codeword data outputted from coding section 207 based on the control information outputted from decoding section 204, generates a data symbol and outputs the data symbol to RB allocation section 209. RB allocation section 209 allocates a resources block to the data symbol outputted from modulation section 208 based on the control information outputted from decoding section 204 and retransmission resource outputted from retransmission resource determining section 205 and outputs the data symbol to multiplexing section 210. Multiplexing section 210 time-multiplexes a pilot signal inputted and transmission data outputted from RB allocation section 209 based on the control information outputted from decoding section 204 and outputs the multiplexed signal to RF transmitting section 211. RF transmitting section 211 applies transmission processing such as D/A conversion, amplification and up-conversion to the transmission data and pilot signal outputted from multiplexing section 210 and transmits the transmission data and pilot signal from antenna 201 to base station 100.

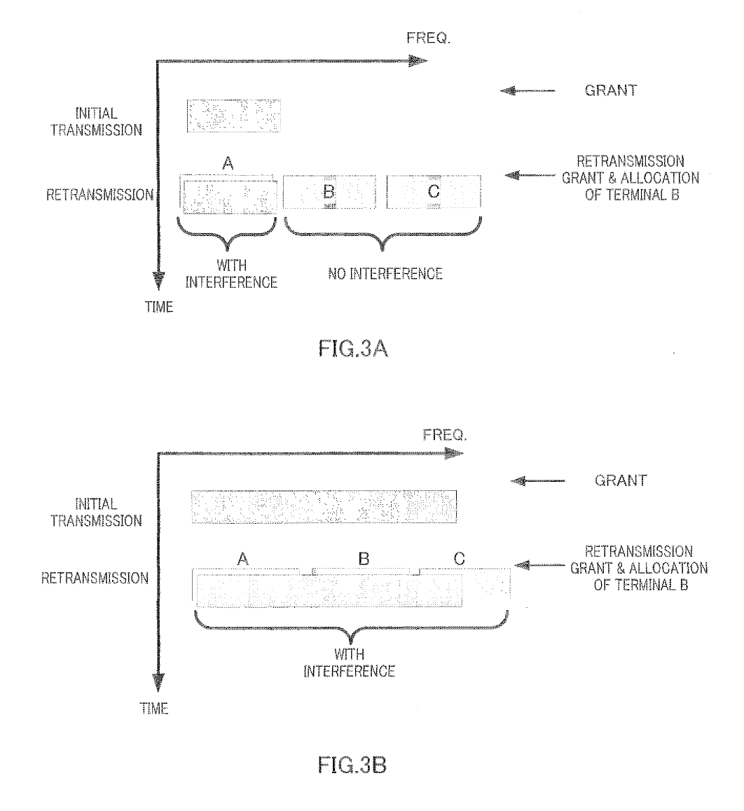

Here, a situation in which resources collide with each other in retransmission of wideband transmission and retransmission of narrow band transmission will be described using FIG. 3. FIG. 3A illustrates a case of retransmission of narrow band transmission and in this case, the terminal that performs retransmission causes interference with only another terminal A. On the other hand, FIG. 3B illustrates a case of retransmission of wideband transmission and in this case, the terminal that performs retransmission widely causes interference with other terminals A to C. From this, it is understandable that retransmission of wideband transmission causes interference with more terminals than retransmission of narrow band transmission.

Thus, the present embodiment stops retransmission when the terminal of wideband transmission cannot detect any retransmission grant as described above. This makes it possible to avoid the terminal of wideband transmission from causing interference with many other terminals and reduce the rate of occurrence of collision between transmission packets.

Thus, according to Embodiment 1, when a terminal whose initial transmission is wideband transmission cannot detect any retransmission grant, it is possible to avoid the terminal of wideband transmission from causing interference with many other terminals by stopping retransmission from the terminal and reduce the rate of occurrence of collision between transmission packets and improve receiving quality of other terminals.

When the number of subcarriers used by the terminal for transmission is assumed to be fixed, if a frequency band is comprised of continuous subcarriers, such a frequency band results in narrower band transmission than a discontinuous frequency band. That is, the above described narrow band transmission may be replaced by a continuous frequency band and the wideband transmission may be replaced by a discontinuous frequency band. Furthermore, the narrow band transmission and wideband transmission may be replaced by localized transmission and distributed transmission described in R1-062513, “Performance comparison between LFDMA and DFSMA transmission in UL”, 3GPP TSG RANI #46bis, Seoul, Korea, Oct. 9-13, 2006, or the like, respectively. That is, the continuous frequency band may be replaced by localized transmission and the discontinuous frequency band may be replaced by distributed transmission.

To be more specific, in a system in which terminals using a discontinuous frequency band and terminals using a continuous frequency band coexist, the base station transmits a combination of NACK and retransmission grant to terminals using a discontinuous frequency band in initial transmission. Furthermore, the base station selects one of only NACK and a combination of NACK and retransmission grant for terminals using a continuous frequency band in initial transmission.

On the other hand, when a terminal using a discontinuous frequency band in initial transmission cannot detect any retransmission grant, the terminal stops retransmission. Furthermore, when a terminal using a continuous frequency band in initial transmission cannot detect any retransmission grant, the terminal performs retransmission using a predetermined resource. When retransmission grant is detected, both the terminal using a discontinuous frequency band and the terminal using a continuous frequency band perform retransmission according to resources indicated by the retransmission grant.

Furthermore, in the system in which terminals that perform distributed transmission and terminals that perform localized transmission coexist, the base station transmits a combination of NACK and retransmission grant to terminals that perform distributed transmission in initial transmission. Furthermore, the base station selects one of only NACK or a combination of NACK and retransmission grant for terminals that perform localized transmission in initial transmission.

On the other hand, when a terminal that has performed JO distributed transmission in initial transmission cannot detect retransmission grant, the terminal stops retransmission. Furthermore, when a terminal that has performed localized transmission in initial transmission cannot detect retransmission grant, the terminal performs retransmission using a predetermined resource. When retransmission grant is detected, both the terminal that performs distributed transmission and the terminal that performs localized transmission perform retransmission according to resources indicated by the retransmission grant.

Here, there is a study on use of localized transmission (or continuous frequency band) by LTE compatible terminals and use of distributed transmission (or discontinuous frequency band) as well as localized transmission (or continuous frequency band) by LTE-Advanced compatible terminals. Furthermore, there is also a study on LTE-Advanced that accommodates not only LTE-Advanced compatible terminals but also LTE compatible terminals and there is a study on LTE-Advanced that allows LTE compatible terminals and LTE-Advanced compatible terminals to coexist in the same frequency band. That is, under LTE-Advanced, there are more terminals using distributed transmission (or discontinuous frequency band) than terminals using localized transmission (or continuous frequency band).

Therefore, when a terminal has been unable to detect any retransmission grant from the base station, it is desirable to take into consideration a terminal using localized transmission (or continuous frequency band) as another terminal that may receive interference from the terminal. Thus, a terminal has been assumed above that uses localized transmission (or continuous frequency band) as another terminal to be allocated to predetermined resources used when retransmission grant is not transmitted when the base station transmits retransmission grant to the terminal.

### Embodiment 2

A base station and a terminal according to Embodiment 2 of the present invention have configurations similar to those according to Embodiment 1 shown in FIG. 1 and FIG. 2 and differ only in some functions, and therefore only different functions will be described using FIG. 1 and FIG. 2.

In the base station according to Embodiment 2 of the present invention, retransmission grant generation section 118 does not generate any retransmission grant with a retransmission count less than N for a terminal using wideband transmission in initial transmission, generates retransmission grant with a retransmission count equal to or more than N and outputs the retransmission grant to coding section 101 as control information.

Furthermore, retransmission grant generation section 118 selects the presence/absence of retransmission grant for a terminal using narrow band transmission in initial transmission, generates, when retransmission grant is necessary, the retransmission grant and outputs the retransmission grant to coding section 101 as control information. N is a positive number and its upper limit is determined by various parameters. Retransmission Grant generation section 118 may also select the presence/absence of retransmission grant with a retransmission count less than N for a terminal using wideband transmission in initial transmission, generate, when retransmission grant is necessary, the retransmission grant and output the retransmission grant to coding section 101 as control information.

In the terminal according to Embodiment 2 of the present invention, retransmission resource determining section 205 judges, when the control information outputted from decoding section 204 includes NACK and retransmission grant, a resource indicated by the retransmission grant as a retransmission resource and outputs the retransmission resource to RB allocation section 209. However, when no retransmission grant can be detected with a retransmission count equal to or more than N and the initial transmission is wideband transmission, retransmission resource determining section 205 judges that there is no retransmission resource and commands RB allocation section 209 to stop retransmission. Furthermore, when no retransmission grant can be detected with a retransmission count less than N and the initial transmission is wideband transmission, and also when no retransmission grant can be detected and the initial transmission is narrow band transmission, retransmission resource determining section 205 judges that the predetermined resource is a retransmission resource and outputs the retransmission resource to RB allocation section 209.

Thus, according to Embodiment 2, when a terminal whose initial transmission is wideband transmission has been unable to detect any retransmission grant with a retransmission count equal to or more than N, it is possible to reduce the amount of signaling by stopping retransmission from the terminal and avoiding transmission of any retransmission grant with a retransmission count less than N.

In a system in which terminals using a discontinuous frequency band and terminals using a continuous frequency band coexist, among terminals using a discontinuous frequency band in initial transmission, (1) the base station transmits only NACK to terminals with a retransmission count less than N and (2) the base station transmits a combination of NACK and retransmission grant to terminals with a retransmission count equal to or more than N. Furthermore, the base station selects the presence/absence of retransmission grant for terminals using a continuous frequency band in initial transmission, transmits a combination of NACK and retransmission grant when the retransmission grant is necessary or transmits only NACK when the retransmission grant is not necessary. For terminals using a discontinuous frequency band in initial transmission and with a retransmission count less than N, the base station may also select the presence/absence of retransmission grant, transmit a combination of NACK and retransmission grant when the retransmission grant is necessary or transmit only NACK when the retransmission grant is not necessary.

On the other hand, as for a terminal side, when a terminal using a discontinuous frequency band in initial transmission has been unable to detect retransmission grant with a retransmission count equal to or more than N, the terminal stops retransmission. Furthermore, when a terminal using a discontinuous frequency band in initial transmission has been unable to detect retransmission grant with a retransmission count less than N, retransmission is performed using a predetermined resource. Furthermore, when a terminal using a continuous frequency band in initial transmission has been unable to detect retransmission grant, the terminal performs retransmission using a predetermined resource. When a terminal using a continuous frequency band or a discontinuous frequency band detects retransmission grant, the terminal performs retransmission according to a resource indicated by the retransmission grant.

Furthermore, in a system in which terminals that perform distributed transmission and terminals that perform localized transmission coexist, among terminals performing distributed transmission in initial transmission, (1) the base station transmits only NACK to terminals with a retransmission count less than N and (2) the base station transmits a combination of NACK and retransmission grant to terminals with a retransmission count equal to or more than N. Furthermore, the base station selects the presence/absence of retransmission grant for terminals using localized transmission in initial transmission, transmits a combination of NACK and retransmission grant when the retransmission grant is necessary or transmits only NACK when the retransmission grant is not necessary. For terminals using distributed transmission in initial transmission and with a retransmission count less than N, the base station may also select the presence/absence of retransmission grant, transmit a combination of NACK and retransmission grant when the retransmission grant is necessary or transmit only NACK when the retransmission grant is not necessary.

On the other hand, as for a terminal side, when a terminal performing distributed transmission in initial transmission and with a retransmission count equal to or more than N has been unable to detect retransmission grant, the terminal stops retransmission. Furthermore, when a terminal that has performed distributed transmission in initial transmission has been unable to detect retransmission grant with a retransmission count less than N, the terminal performs retransmission using a predetermined resource.

Furthermore, a terminal using localized transmission in initial transmission has been unable to detect retransmission grant, the terminal performs retransmission using a predetermined resource. If the retransmission grant is detected, both the terminal performing distributed transmission and the terminal performing localized transmission perform retransmission according to a resource indicated by the retransmission grant.

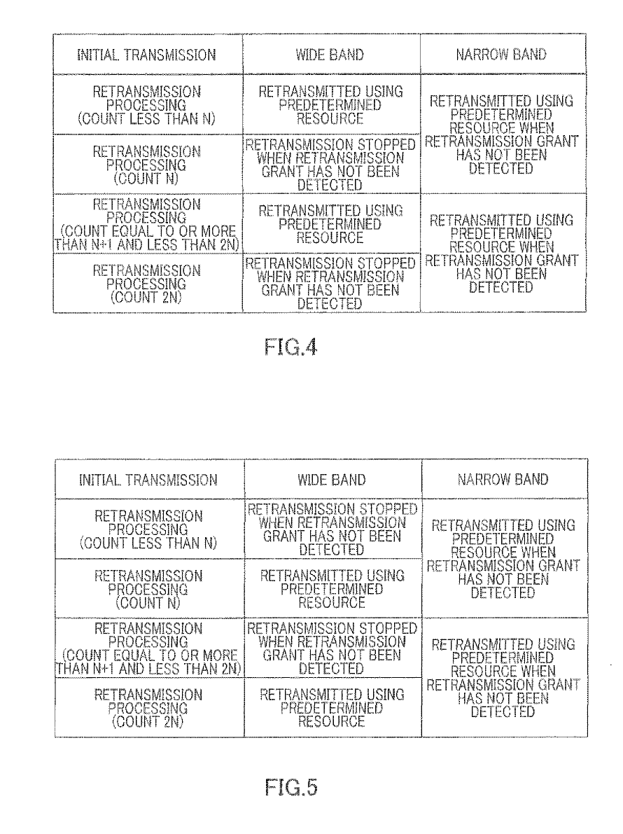

A case has been described in the present embodiment assuming that processing is changed with a count less than N and a count equal to or more than N, but processing may be changed once every N times. For example, in FIG. 4, for terminals whose initial transmission is wideband transmission, the base station transmits a combination of NACK and retransmission grant transmission in an N-th retransmission and transmits only NACK in less than N retransmissions. Furthermore, the base station transmits a combination of NACK and retransmission grant hi a 2N-th retransmission and retransmits only NACK in N+1 or more and less than 2N retransmissions. Similar processing is repeated every N times. A terminal of wideband transmission performs retransmission using a predetermined resource with a count less than N and stops retransmission when the terminal has been unable to detect retransmission grant in an N-th retransmission. Furthermore, the terminal performs retransmission using a predetermined resource at a count equal to or more than N+1 and less than 2N, and stops retransmission at a count 2N when the terminal has been unable to detect retransmission grant. A case has been described assuming that the switching interval is N retransmissions and less than N retransmissions, but the switching interval is not limited to the above described case.

Furthermore, less than N retransmissions in wideband transmission need not be exclusively performed using a predetermined resource and it may be made selectable whether retransmission is performed using a resource indicated by retransmission grant or using a predetermined resource. For example, the base station selects only NACK or a combination of NACK and retransmission grant and transmits this to a terminal of wideband transmission with a retransmission count less than N. When the terminal can detect retransmission grant, the terminal may perform retransmission using a resource indicated by the retransmission grant or perform retransmission using a predetermined resource when the terminal cannot detect retransmission grant.

### Embodiment 3

A base station and a terminal according to Embodiment 3 of the present invention have configurations similar to those according to Embodiment 1 shown in FIG. 1 and FIG. 2 and are different only in some functions, and therefore only different functions will be described using FIG. 1 and FIG. 2.

In the base station according to Embodiment 3 of the present invention, retransmission grant generation section 118 does not generate retransmission grant for terminals using wideband transmission in initial transmission with a retransmission count equal to or more than N, generates retransmission grant with a retransmission count less than N and outputs the retransmission grant to coding section 101 as control information. Furthermore, retransmission grant generation section 118 selects the presence/absence of retransmission grant for terminals using narrow band transmission as initial transmission, generates retransmission grant when the retransmission grant is necessary and outputs the retransmission grant to coding section 101 as control information.

In the terminal according to Embodiment 3 of the present invention, when the control information outputted from decoding section 204 includes NACK and retransmission grant, retransmission resource determining section 205 judges that a resource indicated by the retransmission grant is a retransmission resource and outputs the retransmission resource to RB allocation section 209. However, when retransmission grant cannot be detected with a retransmission count less than N and the initial transmission is wideband transmission, retransmission resource determining section 205 judges that there is no retransmission resource and stops retransmission. Furthermore, when retransmission grant cannot be detected with a retransmission count equal to or more than N and the initial transmission is wideband transmission, and when retransmission grant cannot be detected and the initial transmission is narrow band transmission, retransmission resource determining section 205 judges that a predetermined resource is a retransmission resource and outputs the retransmission resource to RB allocation section 209.

Thus, according to Embodiment 3, when a terminal whose initial transmission is wideband transmission has been unable to detect retransmission grant with a retransmission count less than N, the terminal stops retransmission, does not transmit retransmission grant with a retransmission count equal to or more than N, and can thereby reduce the amount of signaling.

In a system in which terminals using a discontinuous frequency band and terminals using a continuous frequency band coexist, among terminals using a discontinuous frequency band in initial transmission, (1) the base station transmits a combination of NACK and retransmission grant to terminals with a retransmission count less than N and (2) the base station transmits only NACK to terminals with a retransmission count equal to or more than N. Furthermore, for terminals using a continuous frequency band in initial transmission, the base station selects the presence/absence of retransmission grant and transmits a combination of NACK and retransmission grant when the retransmission grant is necessary or transmits only NACK when the retransmission grant is not necessary. For terminals using a discontinuous frequency band in initial transmission and with a retransmission count equal to or more than N, the base station may select the presence/absence of retransmission grant, transmit a combination of NACK and retransmission grant when the retransmission grant is necessary or transmit only NACK when the retransmission grant is not necessary.

On the other hand, on a terminal side, when a terminal using a discontinuous frequency band in initial transmission has been unable to detect retransmission grant with a retransmission count less than N, the terminal stops retransmission. Furthermore, when the terminal using a discontinuous frequency band in initial transmission has been unable to detect retransmission grant with a retransmission count equal to or more than N, the terminal performs retransmission using a predetermined resource. Furthermore, when the terminal using a continuous frequency band in initial transmission has been unable to detect retransmission grant, the terminal performs retransmission using a predetermined resource. When the terminal using a continuous frequency band or discontinuous frequency band detects retransmission grant, the terminal performs retransmission according to a resource indicated by the retransmission grant.

Furthermore, in a system in which terminals that perform distributed transmission and terminals that perform localized transmission coexist, among terminals performing distributed transmission in initial transmission, (1) the base station transmits a combination of NACK and retransmission grant to terminals with a retransmission count less than N and (2) the base station transmits only NACK to terminals with a retransmission count equal to or more than N. Furthermore, for terminals using localized transmission in initial transmission, the base station selects the presence/absence of retransmission grant, transmits a combination of NACK and retransmission grant when the retransmission grant is necessary or transmits only NACK when the retransmission grant is not necessary. For terminals using distributed transmission in initial transmission and with a retransmission count equal to or more than N, the base station may also select the presence/absence of retransmission grant, transmit a combination of NACK and retransmission grant when the retransmission grant is necessary or transmit only NACK when the retransmission grant is not necessary.

On the other hand, on a terminal side, when a terminal performs distributed transmission in initial transmission and has been unable to detect retransmission grant with a retransmission count less than N, the terminal stops retransmission. Furthermore, when a terminal that has performed distributed transmission in initial transmission has been unable to detect retransmission grant with a retransmission count equal to or more than N, the terminal performs retransmission using a predetermined resource. Furthermore, when a terminal using localized transmission in initial transmission has been unable to detect retransmission grant, the terminal performs retransmission using a predetermined resource. Upon detecting retransmission grant, both the terminal that performs distributed transmission and the terminal that performs localized transmission perform retransmission according to a resource indicated by the retransmission grant.

Although a case has been described in the present embodiment assuming that processing is changed with a retransmission count less than N and a retransmission count equal to or more than N, processing may also be changed once every N times. For example, as shown in FIG. 5, for terminals whose initial transmission is wideband transmission, the base station transmits a combination of NACK and retransmission grant at a retransmission count less than N and transmits only NACK with a retransmission count N. Furthermore, the base station transmits a combination of NACK and retransmission grant with a retransmission count equal to or more than N+1 and less than 2N and transmits only NACK with a retransmission count 2N. Similar processing is repeated every N times. When a terminal of wideband transmission has been unable to detect retransmission grant with a retransmission count less than N, the terminal stops retransmission and performs retransmission using a predetermined resource at a retransmission count N. Furthermore, when the terminal has been unable to detect retransmission grant at a retransmission count equal to or more than N+1 and less than 2N, the terminal stops retransmission and performs retransmission using a predetermined resource at a retransmission count 2N. A case has been described assuming that the switching interval is a retransmission count less than N and a retransmission count N, but the switching interval is not limited to this.

Furthermore, retransmission with a retransmission count equal to or more than N in wideband transmission need not exclusively be performed using a predetermined resource, but it may also be made selectable whether retransmission is performed using a resource indicated by retransmission grant or using a predetermined resource. For example, for a terminal with a retransmission count equal to or more than N in wideband transmission, the base station selects only NACK or a combination of NACK and retransmission grant and transmits this. The terminal may perform retransmission using a resource indicated by retransmission grant when the retransmission grant can be detected or perform retransmission using a predetermined resource when the retransmission grant cannot be detected.

In the above described embodiments, examples of the continuous frequency band include continuous subcarriers or subcarriers having predetermined intervals and a band other than the continuous frequency band may be used as the discontinuous frequency band. Furthermore, the continuous frequency band may be called “indiscrete frequency band” and the discontinuous frequency band may be called “discrete frequency band.” Furthermore, the discontinuous frequency band may be replaced by OFDM (Orthogonal Frequency Division Multiplex) and the continuous frequency band may be replaced by SC-OFDM (Single Carrier Frequency Division Multiplex).

Furthermore, although the above described embodiments have been described using wideband transmission and narrow band transmission, wideband transmission and narrow band transmission may be replaced by large and small data sizes or may be replaced by large and small numbers of data pieces per layer. Furthermore, wideband transmission may be transmission using a band exceeding 20 MHz and narrow band transmission may be transmission using a band equal to or below 20 MHz.

Furthermore, although a case has been described in above described Embodiment 1 where a transmitting method of initial transmission (transmission bandwidth, continuity of transmission band or the like) is used as a reference, the present invention is not limited to this, and a transmitting method of retransmission preceding X (X: integer) retransmissions may also be used as a reference. For example, in the ease of an Nth retransmission, a retransmission processing method may be determined based on the (N−1)-th retransmission. That is, the initial transmission may be replaced by the last transmission.

Furthermore, a case has been described in above described Embodiments 2 and 3 where transmission is classified into two types: wideband transmission and narrow band transmission, and discontinuous frequency band and continuous frequency band, but the classification of transmission need not be limited to two types. For example, in Embodiment 2, the value of N may be increased as the band becomes wider. That is, N may be decreased in transmission in an intermediate band between a wideband and a narrow band, and N may be increased in wideband transmission. Furthermore, in Embodiment 3, the value of N may be decreased as the band becomes wider. For example, N may be increased in transmission in an intermediate band and N may be decreased in wideband transmission.

An uplink has been described in the above described embodiments as an example, but a downlink may also be used. Furthermore, HARQ has been described as an example, but ARQ may also be used.

Moreover, although cases have been described with the embodiments above where the present invention is configured by hardware, the present invention may be implemented by software.

Each function block employed in the description of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-250617, filed on. Sep. 29, 2008, including the specification, drawings and abstract, is incorporated herein by reference in its entirety.

### INDUSTRIAL APPLICABILITY

The radio transmitting apparatus and radio transmitting method according to the present invention are applicable, for example, to a radio communication base station apparatus and a radio communication terminal apparatus in a mobile communication system.

1. A radio transmitting apparatus comprising:
a resource allocation section that allocates resources to transmission data;
a transmitting section that transmits the transmission data to which resources are allocated; and
a retransmission resource determining section that commands the resource allocation section to stop retransmission when an initial transmission uses a transmission bandwidth equal to or more than a predetermined value and no retransmission resource allocation signal has been detected.

2. The radio transmitting apparatus according to claim 1, wherein, when the initial transmission uses the transmission bandwidth equal to or more than the predetermined value or the initial transmission uses a discontinuous transmission bandwidth and no retransmission resource allocation signal has been detected, the retransmission resource determining section commands the resource allocation section to stop retransmission.

3. The radio transmitting apparatus according to claim 1, wherein, when a retransmission count is equal to or more than a predetermined count, the initial transmission uses the transmission bandwidth equal to or more than the predetermined value, and no retransmission resource allocation signal has been detected, the retransmission resource determining section commands the resource allocation section to stop retransmission.

4. The radio transmitting apparatus according to claim 1, wherein, when a retransmission count is less than a predetermined count, the initial transmission uses the transmission bandwidth equal to or more than the predetermined value, and no retransmission resource allocation signal has been detected, the retransmission resource determining section commands the resource allocation section to stop retransmission.

5. A radio transmitting method comprising:
a resource allocating step of allocating resources to transmission data;
a transmitting step of transmitting the transmission data to which resources are allocated; and
a retransmission resource determining step of stopping retransmission when an initial transmission uses a transmission bandwidth equal to or more than a predetermined value and no retransmission resource allocation signal has been detected.
